(19) United States
(12) Patent Application Publication
(10) Pub. No.: US 2017/0348948 A1
(43) Pub. Date: Dec. 7, 2017

(54) Barrier film

(71) Applicant: Xiuyan DU, Kowloon (HK)

(72) Inventor: Xiuyan DU, Kowloon (HK)

(21) Appl. No.: 15/172,163

(22) Filed: Jun. 3, 2016

(51) Int. Cl. B32B 27/08; B32B 27/18; B32B 27/34

(52) U.S. Cl. CPC B32B 27/08; B32B 27/34; B32B 27/18; B32B 2250/24; B32B 2307/54; B32B 2250/03

(57) ABSTRACT

A barrier film contains: a first surface layer, a core layer, and a second surface layer. The first surface layer includes 30 wt % to 40 wt % of MXD6, 63 wt % to 85 wt % of PA6, 2 wt % to 4 wt % of anti-sticking masterbatch, 3 wt % to 8 wt % of compatibilizer, and 5.5 wt % to 8 wt % of Nano rare earth nucleating agent. The core layer includes 95 wt % to 99.9 wt % of MXD6 and 0.1 wt % to 5 wt % of Nano rare earth nucleating agent. The second surface layer includes 10 wt % to 30 wt % of MXD6, 63 wt % to 85 wt % of PA6, 2 wt % to 4 wt % of anti-sticking masterbatch, 8.5 wt % to 12 wt % of compatibilizer, and 2 wt % to 4.5 wt % of Nano rare earth nucleating agent. Thereby, the Nano rare earth nucleating agent and compatibilizer are added into the barrier film so as to enhance the tensile strength and the fog density of the barrier film.

### FIELD OF THE INVENTION

The present invention relates to a barrier film which enhances tensile strength and fog density.

### BACKGROUND OF THE INVENTION

MXD6 is polymetaxylylenadipamide acyl phenylene dimethylamine made of xylylenediamine and adipic acid obtained so as to obtain outstanding isolation. CN Publication No. discloses that MXD6 is modified to PA6 in nylon film, wherein MXD6 exist contains large spherical crystals, and PA6 has evenly small spherical crystals but having poor tensile strength, large frangibility, and high fog density.

The present invention has arisen to mitigate and/or obviate the afore-described disadvantages.

### SUMMARY OF THE INVENTION

The primary objective of the present invention is to provide a barrier film in which Nano rare earth nucleating agent and compatibilizer are added so as to enhance the tensile strength and the fog density of the barrier film.

Another objective of the present invention is to provide a barrier film in which the Nano rare earth nucleating agent does not reduce isolation capacity of the barrier film and enhances crystallization to MXD6, for example, before adding the Nano rare earth nucleating agent, large crystals are visible in the core layer, but after adding the Nano rare earth nucleating agent, even crystals produce in the core layer.

To obtain above-mentioned objectives, a barrier film provided by the present invention contains: a first surface layer, a core layer, and a second surface layer.

The first surface layer includes 30 wt % to 40 wt % of MXD6, 63 wt % to 85 wt % of PA6, 2 wt % to 4 wt % of anti-sticking masterbatch, 3 wt % to 8 wt % of compatibilizer, and 5.5 wt % to 8 wt % of Nano rare earth nucleating agent.

The core layer includes 95 wt % to 99.9 wt % of MXD6 and 0.1 wt % to 5 wt % of Nano rare earth nucleating agent.

The second surface layer includes 10 wt % to 30 wt % of MXD6, 63 wt % to 85 wt % of PA6, 2 wt % to 4 wt % of anti-sticking masterbatch, 8.5 wt % to 12 wt % of compatibilizer, and 2 wt % to 4.5 wt % of Nano rare earth nucleating agent.

Preferably, the first surface layer includes 6.0 wt % to 7.5 wt % of the Nano rare earth nucleating agent.

Preferably, the core layer includes 1.5 wt % to 3.5 wt % of the Nano rare earth nucleating agent.

Preferably, the second layer includes 3 wt % of the Nano rare earth nucleating agent.

Preferably, a grain size of the Nano rare earth nucleating agent is in an amount ranging from 10 nm to 500 nm, and a specific surface area of the Nano rare earth nucleating agent is in an amount ranging from 10 m²/g to 100 m²/g, and a bulk specific gravity of the Nano rare earth nucleating agent is in an amount ranging from 0.5 g/cm³ to 2.0 g/cm³.

Preferably, the first surface layer includes 30 wt % of MXD6, 64.5 wt % of PA6, 2 wt % of anti-sticking masterbatch, 3 wt % of PEG 400 extended MXD6, and 6.0 wt % of cerium stearate; the core layer includes 99.5 wt % of MXD6 and 2.0 wt % of cerium stearate; and the second surface layer includes 30 wt % of MXD6, 64.5 wt % of PA6, 2 wt % of anti-sticking masterbatch, 3 wt % of PEG 400 extended MXD6, and 3.0 wt % of cerium stearate.

Preferably, the first surface layer includes 30 wt % of MXD6, 55 wt % of PA6, 2 wt % of anti-sticking masterbatch, 8 wt % of PEG 400 extended MXD6, and 6.5 wt % of lanthanum oxide; the core layer includes 95 wt % of MXD6 and 2.0 wt % of praseodymium oxide; and the second surface layer includes 30 wt % of MXD6, 55 wt % of PA6, 2 wt % of anti-sticking masterbatch, 8 wt % of PEG 400 extended MXD6, and 3.0 wt % of lanthanum oxide.

Preferably, the first surface layer includes 30 wt % of MXD6, 60.5 wt % of PA6, 2 wt % of anti-sticking masterbatch, 5.5 wt % of PEG 400 extended MXD6, and 6.0 wt % of tungsten oxide; the core layer includes 98 wt % of MXD6 and 2.0 wt % of tungsten oxide; and the second surface layer includes 30 wt % of MXD6, 60.5 wt % of PA6, 2 wt % of anti-sticking masterbatch, 5.5 wt % of PEG 400 extended MXD6, and 3.0 wt % of tungsten oxide.

Preferably, the Nano rare earth nucleating agent is any one of cerium stearate, cerium chloride, lanthanum oxide, fumaric lanthanum, and tungsten oxide or is a combination of at least two of cerium stearate, cerium chloride, lanthanum oxide, fumaric lanthanum, and tungsten oxide.

Preferably, the compatibilizer is the PEG 400 extended MXD6, and the compatibilizer is in an amount ranging from 4 wt % to 6 wt %.

### BRIEF DESCRIPTION OF THE DRAWINGS

FIG. 1 is Table 1 illustrating comparison among the first embodiment, the second embodiment, the third embodiment, and the comparative example.

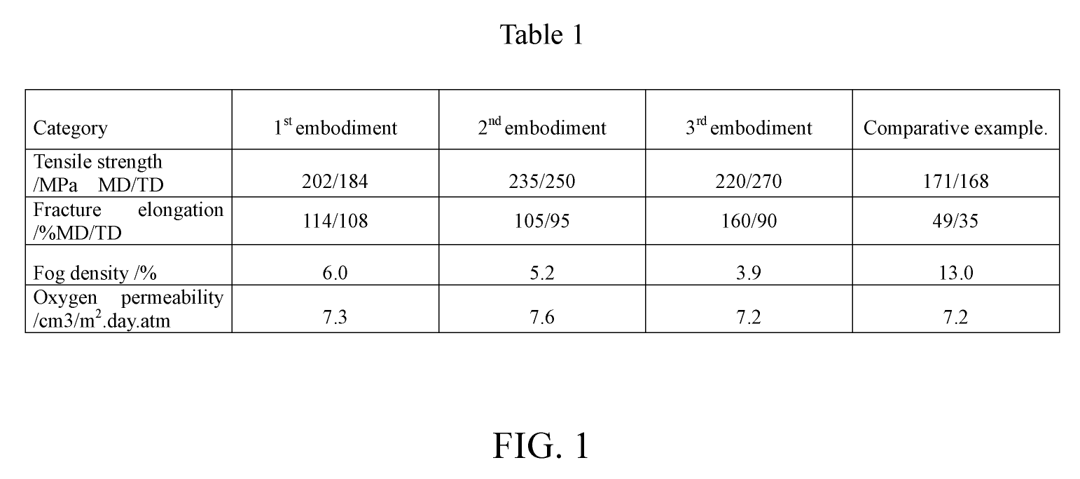

### DETAILED DESCRIPTION OF THE PREFERRED EMBODIMENTS

A barrier film according to a first embodiment of the present invention comprises: a first surface layer a, a core layer, and a second surface layer b, wherein the first surface layer a includes 30 wt % of MXD6, 64.5 wt % of PA6, 2 wt % of anti-sticking masterbatch, 3 wt % of PEG 400 extended MXD6, and 6.0 wt % of cerium stearate; the core layer includes 99.5 wt % of MXD6 and 2.0 wt % of cerium stearate; and the second surface layer b includes 30 wt % of MXD6, 64.5 wt % of PA6, 2 wt % of anti-sticking masterbatch, 3 wt % of PEG 400 extended MXD6, and 3 wt % of cerium stearate.

A barrier film according to a second embodiment of the present invention comprises: a first surface layer a, a core layer, and a second surface layer b, wherein the first surface layer a includes 30 wt % of MXD6, 55 wt % of PA6, 2 wt % of anti-sticking masterbatch, 8 wt % of PEG 400 extended MXD6, and 6.5 wt % of lanthanum oxide; the core layer includes 95 wt % of MXD6 and 2.0 wt % of praseodymium oxide; and the second surface layer b includes 30 wt % of MXD6, 55 wt % of PA6, 2 wt % of anti-sticking masterbatch, 8 wt % of PEG 400 extended MXD6, and 3 wt % of lanthanum oxide.

A barrier film according to a third embodiment of the present invention comprises: a first surface layer a, a core layer, and a second surface layer b, wherein the first surface layer a includes 30 wt % of MXD6, 60.5 wt % of PA6, 2 wt % of anti-sticking masterbatch, 5.5 wt % of PEG 400 extended MXD6, and 6.0 wt % of tungsten oxide; the core layer includes 98 wt % of MXD6 and 2.0 wt % of tungsten oxide; and the second surface layer b includes 30 wt % of MXD6, 60.5 wt % of PA6, 2 wt % of anti-sticking masterbatch, 5.5 wt % of PEG 400 extended MXD6, and 3 wt % of tungsten oxide.

Referring to Table 1, in a comparative example, a barrier film comprises a first surface layer a, a core layer, and a second surface layer b, wherein the first surface layer a includes 30 wt % of MXD6, 68 wt % of PA6, and 2 wt % of anti-sticking masterbatch; the core layer includes 100 wt % of MXD6; and the second surface layer b includes 30 wt % of MXD6, 68 wt % of PA6, and 2 wt % of anti-sticking masterbatch.

Furthermore, Table 1 illustrates comparison among the first embodiment, the second embodiment, the third embodiment, and the comparative example.

It is to be noted that a grain size of the Nano rare earth nucleating agent is in an amount ranging from 10 nm to 500 nm, and a specific surface area of the Nano rare earth nucleating agent is in an amount ranging from 10 m²/g to 100 m²/g, and a bulk specific gravity of the Nano rare earth nucleating agent is in an amount ranging from 0.5 g/cm³ to 2.0 g/cm³.

Preferably, the Nano rare earth nucleating agent is any one of cerium stearate, cerium chloride, lanthanum oxide, fumaric lanthanum, and tungsten oxide or is a combination of at least two of cerium stearate, cerium chloride, lanthanum oxide, fumaric lanthanum, and tungsten oxide.

In addition, the compatibilizer is the PEG 400 extended MXD6, and the compatibilizer is in an amount ranging from 4 wt % to 6 wt %.

Thereby, as listed in the Table 1, Nano rare earth nucleating agent and compatibilizer are added in the first embodiment, the second embodiment, and the third embodiment so as to enhance the tensile strength and the fog density of the barrier film. Preferably, the Nano rare earth nucleating agent does not reduce isolation capacity of the barrier film and enhances crystallization to MXD6. For example, before adding the Nano rare earth nucleating agent, large crystals are visible in the core layer, but after adding the Nano rare earth nucleating agent, even crystals produce in the core layer.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A barrier film comprising:
a first surface layer, a core layer, and a second surface layer;
wherein the first surface layer includes 30 wt % to 40 wt % of MXD6, 63 wt % to 85 wt % of PA6, 2 wt % to 4 wt % of anti-sticking masterbatch, 3 wt % to 8 wt % of compatibilizer, and 5.5 wt % to 8 wt % of Nano rare earth nucleating agent;
wherein the core layer includes 95 wt % to 99.9 wt % of MXD6 and 0.1 wt % to 5 wt % of Nano rare earth nucleating agent;
wherein the second surface layer includes 10 wt % to 30 wt % of MXD6, 63 wt % to 85 wt % of PA6, 2 wt % to 4 wt % of anti-sticking masterbatch, 8.5 wt % to 12 wt % of compatibilizer, and 2 wt % to 4.5 wt % of Nano rare earth nucleating agent.

2. The barrier film as claimed in claim 1, wherein the first surface layer includes 6.0 wt % to 7.5 wt % of the Nano rare earth nucleating agent.

3. The barrier film as claimed in claim 1, wherein the core layer includes 1.5 wt % to 3.5 wt % of the Nano rare earth nucleating agent.

4. The barrier film as claimed in claim 1, wherein the second layer includes 3 wt % of the Nano rare earth nucleating agent.

5. The barrier film as claimed in claim 1, wherein a grain size of the Nano rare earth nucleating agent is in an amount ranging from 10 nm to 500 nm, and a specific surface area of the Nano rare earth nucleating agent is in an amount ranging from 10 m²/g to 100 m²/g, and a bulk specific gravity of the Nano rare earth nucleating agent is in an amount ranging from 0.5 g/cm³ to 2.0 g/cm³.

6. The barrier film as claimed in claim 1, wherein the first surface layer includes 30 wt % of MXD6, 64.5 wt % of PA6, 2 wt % of anti-sticking masterbatch, 3 wt % of PEG 400 extended MXD6, and 6.0 wt % of cerium stearate; the core layer includes 99.5 wt % of MXD6 and 2.0 wt % of cerium stearate; and the second surface layer includes 30 wt % of MXD6, 64.5 wt % of PA6, 2 wt % of anti-sticking masterbatch, 3 wt % of PEG 400 extended MXD6, and 3.0 wt % of cerium stearate.

7. The barrier film as claimed in claim 1, wherein the first surface layer includes 30 wt % of MXD6, 55 wt % of PA6, 2 wt % of anti-sticking masterbatch, 8 wt % of PEG 400 extended MXD6, and 6.5 wt % of lanthanum oxide; the core layer includes 95 wt % of MXD6 and 2.0 wt % of praseodymium oxide; and the second surface layer includes 30 wt % of MXD6, 55 wt % of PA6, 2 wt % of anti-sticking masterbatch, 8 wt % of PEG 400 extended MXD6, and 3.0 wt % of lanthanum oxide.

8. The barrier film as claimed in claim 1, wherein the first surface layer includes 30 wt % of MXD6, 60.5 wt % of PA6, 2 wt % of anti-sticking masterbatch, 5.5 wt % of PEG 400 extended MXD6, and 6.0 wt % of tungsten oxide; the core layer includes 98 wt % of MXD6 and 2.0 wt % of tungsten oxide; and the second surface layer includes 30 wt % of MXD6, 60.5 wt % of PA6, 2 wt % of anti-sticking masterbatch, 5.5 wt % of PEG 400 extended MXD6, and 3.0 wt % of tungsten oxide.

9. The barrier film as claimed in claim 1, wherein the Nano rare earth nucleating agent is any one of cerium stearate, cerium chloride, lanthanum oxide, fumaric lanthanum, and tungsten oxide or is a combination of at least two of cerium stearate, cerium chloride, lanthanum oxide, fumaric lanthanum, and tungsten oxide.

10. The barrier film as claimed in claim 1, wherein the compatibilizer is the PEG 400 extended MXD6, and the compatibilizer is in an amount ranging from 4 wt % to 6 wt %.
